(19) United States
(12) Patent Application Publication
(10) Pub. No.: US 2011/0064053 A1
(43) Pub. Date: Mar. 17, 2011

(54) HANDOVER MANAGEMENT METHOD IN WIRELESS COMMUNICATION SYSTEM

(76) Inventors: Jae Sun Cha, Daejeon (KR); Chul Sik Yoon, Seoul (KR); Seok Heon Cho, Daejon (KR)

(21) Appl. No.: 12/920,251

(22) PCT Filed: Aug. 29, 2008
(86) PCT No.: PCT/KR08/05101

§ 371 Date: Nov. 19, 2010

(30) Foreign Application Priority Data
Feb. 28, 2008 (KR) 10-2008-0018397
May 27, 2008 (KR) 10-2008-0048961

(51) Int. Cl. H04W 36/00

(52) U.S. Cl. 370/331

(57) ABSTRACT

The present invention relates to a handover management method that can reduce a service interruption time due to handover of a mobile station in a wideband wireless access system. A handover management method according to an exemplary embodiment of the present invention includes receiving a handover request message from a serving base station, transmitting a handover response message that includes a basic channel identifier to be allocated to a mobile station, receiving a ranging request message from the mobile station using the basic channel identifier, and using the basic channel identifier to start uplink/downlink communication with the mobile station.

### TECHNICAL FIELD

The present invention relates to a handover management method in a wireless communication system, and more particularly, to a handover management method that can reduce a service interruption time due to handover of a mobile station in a wideband wireless access system.

### BACKGROUND ART

A wideband wireless access system is a next-generation communication method that applies mobility to a local area data communication method using a fixed access point. Various standards for the wideband wireless access system are being suggested and the international standardization is being actively made in the IEEE 802.16.

A wireless local area network (LAN) method according to the related art applies wireless communication within a local area from a fixed access point, and thus applies wireless communication, not wired communication. However, the wireless LAN method cannot secure mobility of a mobile station.

Meanwhile, a wideband wireless access method that is suggested by the IEEE 802.16(e) can secure mobility of a mobile station even when the mobile station moves from a cell covered by one base station to a cell covered by another base station. However, according to the wideband wireless access method, a handover management method is needed to provide a data communication service without interruption when the mobile station moves from a cell covered by one base station to a cell covered by another base station.

In a handover management method according to the related art, if a mobile station transmits a handover request (hereinafter, simply referred to as “HO-REQ”) message to a serving base station, the serving base station inspects whether a neighboring base station can accept a handover request from the mobile station and transmits to the mobile station a handover response (hereinafter, simply referred to as “HO-RSP”) message including a list of one or more target base stations applying handover to the mobile station.

Then, the mobile station selects one of the target base stations included in the HO-RSP message and transmits a handover indication (hereinafter, simply referred to as “HO-IND”) message including an identifier of the corresponding target base station to the serving base station. The mobile station interrupts uplink/downlink data transmission immediately after transmitting the HO-IND message, and the serving base station interrupts uplink/downlink data transmission immediately after receiving the HO-IND message from the mobile station.

The mobile station receives a wireless frame transmitted by the target base station and acquires downlink synchronization. Then, the mobile station selects an arbitrary CDMA code from among CDMA codes for handover and transmits the selected CDMA code to the target base station to perform handover ranging. The target base station that has received the CDMA code for handover from the mobile station transmits a first ranging response (hereinafter, simply referred to as “first RNG-RSP”) message to the mobile station and allocates an uplink resource. The mobile station transmits a ranging request (hereinafter, simply referred to as “RNG-REQ”) message during an uplink resource interval allocated by the target base station.

The target base station that has received the RNG-REQ message inspects whether the RNG-REQ message and the mobile station are authorized, and transmits a second ranging response (hereinafter, simply referred to as “second RNG-RSP”) message including a radio channel identifier to be used by the mobile station and message authentication tuple information to the mobile station.

The mobile station that has received the second RNG-RSP message inspects whether the second RNG-RSP message is authorized, and uses the information included in the second RNG-RSP message to update predetermined radio channel information.

A handover procedure ends immediately after the mobile station receives a second RNG-RSP message. However, in order to restart wireless communication, the predetermined radio channel needs to be updated on the basis of the information received from the target base station through the second RNG-RSP message. For this reason, some delay time is additionally required in order to actually restart uplink/downlink wireless communication.

Accordingly, a service interrupt time, where a user feels ranges from a point of time when the mobile station transmits the HO-IND message to the serving base station to a point of time when the mobile station receives the second RNG-RSP message from the target base station, and radio channel information is completely updated.

In order to reduce the service interruption time, a network reentry procedure with the target base station needs to be simplified to enable uplink/downlink communication to restart in a short time. However, according to the related art, since a radio channel to be used by the target base station is newly allocated during a handover procedure, an exchange of RNG-REQ/RSP messages is essentially required in order to allow the newly allocated radio channel to be shared between the mobile station and the target base station. As a result, it is difficult to reduce the service interruption time that is generated during the handover.

The above information disclosed in this Background section is only for enhancement of understanding of the background of the invention and therefore it may contain information that does not form the prior art that is already known in this country to a person of ordinary skill in the art.

### DISCLOSURE OF INVENTION

### Technical Problem

The present invention has been made in an effort to provide a handover management method, having advantages of reducing a service interruption time due to handover.

### Technical Solution

An exemplary embodiment of the present invention provides a handover management method of a base station. The handover management method includes receiving a handover request message from a serving base station, transmitting a handover response message that includes a basic channel identifier to be allocated to a mobile station, receiving a ranging request message from the mobile station using the basic channel identifier, and using the basic channel identifier to start uplink/downlink communication with the mobile station.

Another exemplary embodiment of the present invention provides a handover method of a mobile station. The handover method includes transmitting a handover request message to a serving base station, receiving a handover response message that includes a list of base stations recommended to a target base station by the serving base station and adjacent to the mobile station and basic channel identifiers allocated by the neighboring base stations, using a basic channel identifier allocated by the selected target base station to transmit a ranging request message, and using the basic channel identifier allocated by the selected target base station and channel identifiers allocated by the serving base station to start uplink/downlink communication with the selected target base station.

Still another exemplary embodiment of the present invention provides a handover management method of a base station. The handover management method includes receiving a handover request message from a serving base station, transmitting a handover response message that includes a basic channel identifier to be allocated to a mobile station and a code for handover, receiving the code for handover from the mobile station, and transmitting a ranging response message using the basic channel identifier and starting uplink/downlink wireless communication.

A further exemplary embodiment of the present invention provides a handover method of a mobile station. The handover method includes: transmitting a handover request message to a serving base station; receiving a handover response message, which includes a list of base stations recommended to a target base station by the serving base station and adjacent to the mobile station, basic channel identifiers allocated by the neighboring base stations, and codes for handover; and selecting one of the neighboring base stations as the target base station and transmitting codes for handover allocated by the target base station to the target base station.

### ADVANTAGEOUS EFFECTS

According to the exemplary embodiments of the present invention, uplink/downlink communication restarts between a mobile station and a target base station before a handover procedure between the mobile station and the target base station ends so as to reduce a service interruption time generated during handover, thereby improving handover performance.

### BRIEF DESCRIPTION OF THE DRAWINGS

FIG. 1 is a flowchart illustrating a handover management method according to a first exemplary embodiment of the present invention.

FIG. 2 is a flowchart illustrating a handover management method according to a second exemplary embodiment of the present invention.

FIG. 3 is a diagram illustrating a wireless frame that is transmitted by a target base station when the target base station performs uplink/downlink wireless communication with a first mobile station performing handover to the target base station and a second mobile station providing a service within the service coverage of the target base station.

### MODE FOR THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise”, and variations such as “comprises” and “comprising”, will be understood to imply the inclusion of stated elements but not the exclusion of any other elements. In addition, the terms “-er” and “-or” described in the specification mean units for processing at least one function and operation and can be implemented by hardware components, software components, or combinations thereof.

In this specification, a mobile station (MS) may designate a terminal, a mobile terminal (MT), a subscriber station (SS), a portable subscriber station (PSS), user equipment (UE), or an access terminal (AT), and include a part or all of the functions of the mobile terminal, the subscriber station, the portable subscriber station, the user equipment, and the access terminal.

In this specification, a base station (BS) may designate an access point (AP), a radio access station (RAS), a node B, a base transceiver station (BTS), or a mobile multihop relay (MMR)-BS, and include a portion or all of functions thereof.

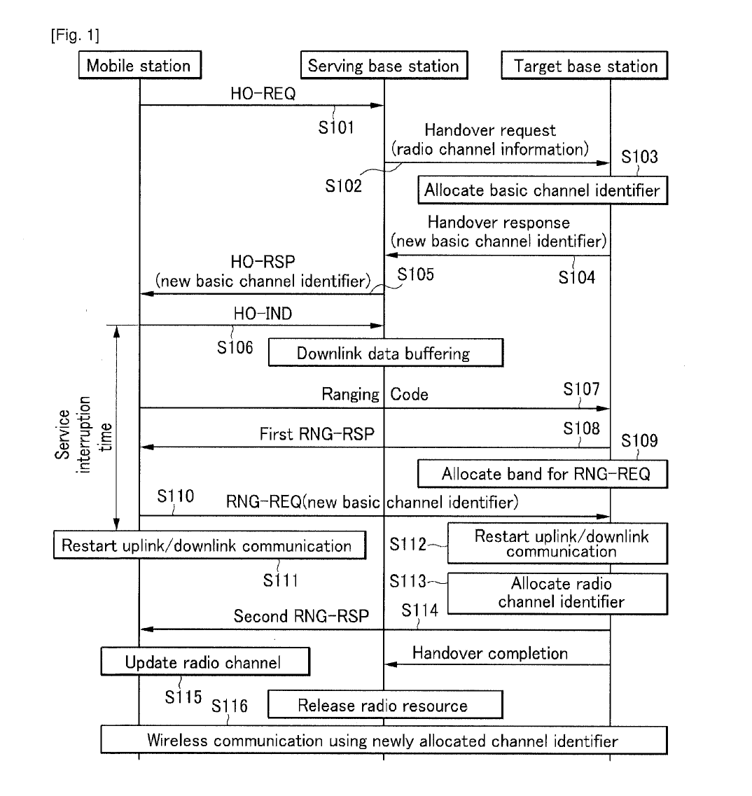

Hereinafter, a handover management method according to a first exemplary embodiment of the present invention will be described in detail with reference to FIG. 1. FIG. 1 is a flowchart illustrating a handover management method according to a first exemplary embodiment of the present invention.

The handover management method according to the first exemplary embodiment of the present invention uses a competition-based handover ranging method at the time of reentering a network.

Referring to FIG. 1, a mobile station that performs wireless communication with a serving base station occasionally measures quality of a radio signal received from a neighboring base station and determines whether handover needs to be performed. When it is determined that handover needs to be performed, the mobile station transmits a HO-REQ message to the serving base station and requests the serving base station to perform handover (S101). At this time, the HO-REQ message includes wireless quality of the neighboring base station that is measured by the mobile station, and the wireless quality of the neighboring base station is used when the serving base station recommends a target base station to the mobile station.

After receiving the HO-REQ message, the serving base station refers to a list of base stations included in the HO-REQ message and transmits a handover request message to each neighboring base station to inquire whether each neighboring base station can accept a handover request from the mobile station (S102). At this time, the handover request message includes mobile station information and predetermined radio channel information between the mobile station and the serving base station. The radio channel information includes a channel identifier.

After receiving the handover request message from the serving base station, the neighboring base station uses information included in the handover request message to determine whether the neighboring base station can accept a handover request from the mobile station. When it is determined that the neighboring base station can accept a handover request from the mobile station, the mobile station allocates a basic channel identifier (Basic CID) to be used in the neighboring base station (S103). Then, the neighboring base station transmits a handover response message that includes information on whether a handover request can be accepted and a newly allocated basic channel identifier to the serving base station (S104).

The serving base station transmits a HO-RSP message that includes the basic channel identifier allocated by the neighboring base station to the mobile station (S105). The HO-RSP message includes a list of neighboring base stations that the serving base station recommends to the target base station and basic channel identifiers allocated by the individual neighboring base stations.

The mobile station that has received the HO-RSP message transmits a HO-TND message, which includes an identifier of a neighboring base station obtained by selecting any one of the neighboring base stations included in the HO-RSP message, to the serving base station (S106). The mobile station interrupts uplink/downlink wireless communication with the serving base station and performs a network reentry procedure to the selected target base station.

Meanwhile, the serving base station that has received the HO-IND message interrupts downlink wireless communication and stores downlink data received from a network until a handover completion message is received from the target base station.

The mobile station receives a wireless frame that is transmitted by the target base station to acquire downlink synchronization, and performs handover ranging (S107). The mobile station selects an arbitrary CDMA code from among CDMA codes for handover allocated to perform handover ranging with the target base station and transmits the selected CDMA code to the target base station. The target base station that has received the CDMA code for handover transmits a first RNG-RSP message to the mobile station (S108), and allocates an uplink resource such that the mobile station can transmit an RNG-REQ message (S109).

The mobile station that has received the first RNG-RSP message transmits the RNG-REQ message to the target base station (S110). In the related art, since a mobile station is not allocated with a channel identifier that the mobile station uses, the mobile station fixes a value of a channel identifier of a radio channel needed to transmit a RNG-REQ message to ‘0’. According to the first exemplary embodiment of the present invention, the mobile station uses a basic channel identifier allocated by the target base station as a channel identifier of a radio channel needed to transmit the RNG-REQ message. Here, the mobile station receives the basic channel identifier via the serving base station.

Immediately after transmitting the RNG-REQ message, the mobile station uses the basic channel identifier allocated by the target base station and channel identifiers used by the mobile station to perform wireless communication with the serving base station to restart uplink/downlink communication (S111).

Meanwhile, when a value of a channel identifier that is included in a header of the RNG-REQ message is not ‘0’ but the same as the value of the previously allocated basic channel identifier, the target base station that has received the RNG-REQ message uses the basic channel identifier and the channel identifiers that the mobile station receives from the serving base station to perform wireless communicate with the serving base station to restart uplink/downlink communication (S112). The target base station continuously performs a network reentry procedure with the mobile station, separately from the restart of the uplink/downlink communication.

The target base station allocates a new radio channel identifier that the mobile station uses when performing communication with the target base station (S113), and transmits a second RNG-RSP message including the new radio channel identifier to the mobile station (S114).

The mobile station that has received the second RNG-RSP message uses the radio channel identifier included in the second RNG-RSP message to update a radio channel (S115), and uses a channel identifier newly allocated after a predetermined time to perform uplink/downlink wireless communication (S116).

Also, the target base station that has transmitted the second RNG-RSP message uses a channel identifier newly allocated after a predetermined time to perform uplink/downlink wireless communication (S116).

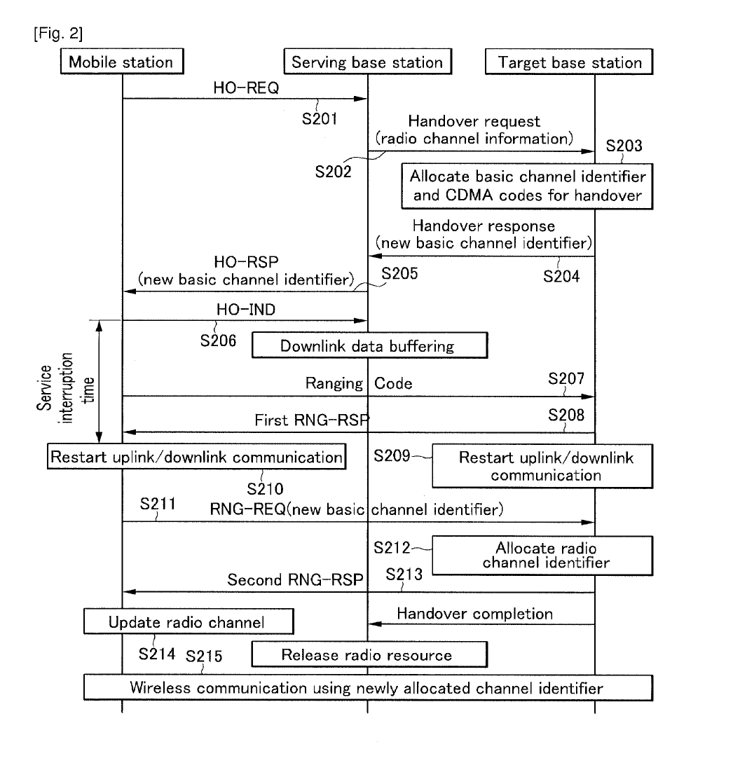

Next, a handover management method according to a second exemplary embodiment of the present invention will be described with reference to FIG. 2. FIG. 2 is a flowchart illustrating a handover management method according to a second exemplary embodiment of the present invention.

The handover management method according to the second exemplary embodiment of the present invention uses a noncompetition-based handover ranging method at the time of reentering a network.

Referring to FIG. 2, a mobile station transmits a HO-REQ message to a serving base station to request the serving base station to perform handover (S201), and the serving base station that has received the HO-REQ message transmits a handover request message to each neighboring base station (S202).

When it is determined that a handover request from the mobile station can be accepted, the neighboring base station that has received the handover request message from the serving base station allocates a basic channel identifier (Basic CID) that is to be used by the mobile station in the neighboring base station, and determines a CDMA code for handover that the mobile station transmits at the time of reentering a network and transmission point of time of the CDMA codes for handover (S203). Then, the neighboring base station transmits a handover response message including the basic channel identifier, the CDMA code for handover, and the transmission point of time of the CDMA codes for handover to the serving base station (S204).

Then, the serving base station transmits a HO-RSP message including the basic channel identifier allocated by the neighboring base station, the CDMA code for handover, and the transmission point of time of the CDMA code for handover to the mobile station (S205). The HO-RSP message includes a list of neighboring base stations that the serving base station recommends to the target base station and basic channel identifiers allocated by the individual neighboring base stations.

The mobile station that has received the HO-RSP message transmits a HO-IND message, which includes an identifier of a neighboring base station obtained by selecting any one of the neighboring base stations included in the HO-RSP message, to the serving base station (S206), and performs a network reentry procedure to the selected target base station.

Meanwhile, the serving base station that has received the HO-IND message interrupts downlink wireless communication and stores downlink data received from a network until a handover completion message is received from the target base station.

The mobile station receives a wireless frame that is transmitted by the target base station to acquire downlink synchronization, and performs handover ranging (S207). The mobile station transmits the CDMA code for handover allocated by the target base station to perform handover ranging with the target base station to the target base station at the transmission point of time of the CDMA code for handover determined by the target base station.

When the target base station receives the CDMA code for handover allocated by the target base station at the transmission point of time of the CDMA code for handover determined by the target base station, the target base station determines that the mobile station starts a network reentry procedure for handover. The target base station uses the basic channel identifier allocated to the mobile station to transmit the first RNG-RSP message (S208) and restarts uplink/downlink wireless communication (S209).

Meanwhile, when receiving the first RNG-RSP message including the basic channel identifier allocated by the target base station from the target base station, the mobile station uses the basic channel identifier and the channel identifiers previously used to perform wireless communication with the serving base station to restart the uplink/downlink wireless communication (S210).

Then, the mobile station and the target base station perform a network reentry procedure according to the procedure in the first exemplary embodiment of the present invention.

That is, differently from the handover management method according to the first exemplary embodiment of the present invention in which an arbitrary CDMA code is selected from among the CDMA codes allocated for handover at the time of reentering a network and then transmitted, the handover management method according to the second exemplary embodiment of the present invention transmits the CDMA code for handover that is allocated by the target base station before a network reentry procedure.

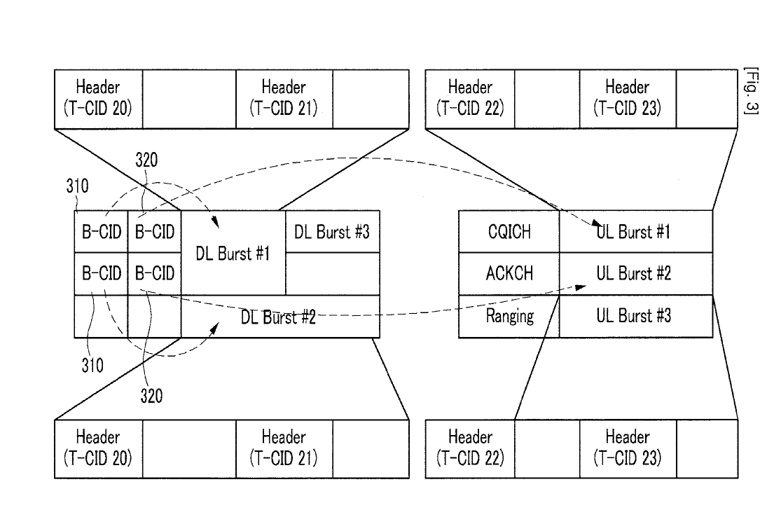

Hereinafter, a burst allocation method in a wideband wireless access system according to an exemplary embodiment of the present invention will be described with reference to FIG. 3.

FIG. 3 is a diagram illustrating a wireless frame that is transmitted by a target base station when the target base station performs uplink/downlink wireless communication with a first mobile station performing handover to the target base station and a second mobile station providing a service within the service coverage of the target base station.

As shown in FIG. 3, the base station allocates uplink/downlink burst to the wireless frame and transmits the wireless frame including a head where a MAP is stored in order to inform allocation of the uplink/downlink burst. In this case, the MAP includes an uplink MAP 310 and a downlink MAP 320. Each of the uplink MAP 310 and the downlink MAP 320 includes the basic channel identifier allocated to the mobile station and a location of burst allocated to the mobile station in the frame.

The burst that is indicated by the MAP may include at least one MAC PDU that is transmitted to the mobile station, and a header of each PDU includes channel identifiers in order to indicate a destination of each PDU.

All of the basic channel identifiers that are allocated to the first mobile station and the second mobile station are allocated uniquely by the target base station. The mobile station that is allocated with the uplink/downlink burst on the MAP is discriminated on the basis of the allocated basic channel identifiers.

However, the case of the channel identifiers that are included in the burst is different from the above case. The channel identifiers that are allocated to the first mobile station are allocated uniquely by the serving base station and the channel identifiers that are allocated to the second mobile station are allocated uniquely by the target base station. Accordingly, in the channel identifiers that are included in the burst, the channel identifiers that are used by the first mobile station may be the same as the channel identifiers that are used by the second mobile station, as shown in FIG. 3.

However, the target base station refers to the basic channel identifiers included in the MAP to determine channel identifiers to be used hereinafter. When the used basic channel identifier is the basic channel identifier that is allocated to the mobile station performing handover, the target base station determines that channel identifiers to be used hereinafter in the burst are allocated to the mobile station by the serving base station and used by the mobile station. Accordingly, even though the channel identifiers used in the burst overlap between mobile stations, the base station can correctly analyze a destination of the corresponding burst and PDU as long as the basic channel identifiers do not overlap.

The exemplary embodiment of the present invention that has been described above may be implemented by not only an apparatus and a method but also a program capable of realizing a function corresponding to the structure according to the exemplary embodiment of the present invention and a recording medium having the program recorded therein. It can be understood by those skilled in the art that the implementation can be easily made from the above-described exemplary embodiment of the present invention.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A handover management method of a base station, comprising:
receiving a handover request message from a serving base station;
transmitting a handover response message that includes a basic channel identifier to be allocated to a mobile station;
receiving a ranging request message from the mobile station using the basic channel identifier; and
using the basic channel identifier to start uplink/downlink communication with the mobile station.

2. The handover management method of claim 1, wherein:
the handover request message includes channel identifiers that are used between the serving base station and the mobile station; and
the starting of the uplink/downlink communication is starting uplink/downlink communication with the mobile station using the basic channel identifier and the channel identifiers.

3. The handover management method of claim 2, wherein the basic channel identifier is allocated by the target base station, and the channel identifiers are allocated by the serving base station.

4. A handover method of a mobile station, comprising:
transmitting a handover request message to a serving base station;
receiving a handover response message, which includes a list of base stations recommended to a target base station by the serving base station and adjacent to the mobile station and basic channel identifiers allocated by the neighboring base stations;
using a basic channel identifier allocated by the target base station to transmit a ranging request message; and
using the basic channel identifier allocated by the selected target base station and channel identifiers allocated by the serving base station to start uplink/downlink communication with the selected target base station.

5. The handover method of claim 4, further comprising:
selecting an arbitrary code from among codes for handover that are previously allocated to perform handover ranging with the target base station and transmitting the selected code to the target base station.

6. The handover method of claim 4, further comprising:
selecting one of the neighboring base stations as the target base station, transmitting a handover indication message including an identifier of the selected target base station to the serving base station, and interrupting wireless communication with the serving base station.

7. A handover management method of a base station, comprising:
receiving a handover request message from a serving base station;
transmitting a handover response message that includes a basic channel identifier to be allocated to a mobile station and codes for handover;
receiving the codes for handover from the mobile station; and
transmitting a ranging response message using the basic channel identifier and starting uplink/downlink wireless communication.

8. The handover management method of claim 6, wherein:
the handover request message includes channel identifiers that are used between the serving base station and the mobile station; and
the starting of the uplink/downlink wireless communication is starting uplink/downlink communication with the mobile terminal using the basic channel identifier and the channel identifiers.

9. A handover method of a mobile station, comprising,
transmitting a handover request message to a serving base station;
receiving a handover response message, which includes a list of base stations recommended to a target base station by the serving base station and adjacent to the mobile station, basic channel identifiers allocated by the neighboring base stations, and a code for handover; and
selecting one of the neighboring base stations as the target base station and transmitting the code for handover allocated by the target base station to the target base station.

10. The handover method of claim 9, further comprising:
receiving a ranging response message from the target base station using a basic channel identifier allocated by the target base station; and
using the basic channel identifier allocated the target base station and the channel identifiers allocated by the serving base station to start uplink/downlink wireless communication with the target base station.

11. The handover method of claim 9, wherein:
the handover response message further includes transmission points of time of CDMA codes for handover; and
the transmitting of the code for handover is transmitting the code for handover allocated by the target base station to the target base station at the transmission point of time of the CDMA code for handover.
